(19) United States
(12) Patent Application Publication
(10) Pub. No.: US 2012/0133748 A1
(43) Pub. Date: May 31, 2012

(54) SIGNAL PROCESSING METHOD AND APPARATUS THEREFOR USING SCREEN SIZE OF DISPLAY DEVICE

(76) Inventors: Hyun-Kwon CHUNG, Seoul (KR); Bong-Gil Bak, Suwon-si (KR); Sung-Ryeul Rhyu, Yongin-si (KR)

(21) Appl. No.: 13/345,838

(22) Filed: Jan. 9, 2012

Related U.S. Application Data
(63) Continuation of application No. PCT/KR2010/004416, filed on Jul. 7, 2010.
(60) Provisional application No. 61/224,106, filed on Jul. 9, 2009.
(60) Provisional application No. 61/272,153, filed on Aug. 21, 2009.
(60) Provisional application No. 61/228,209, filed on Jul. 24, 2009.
(60) Provisional application No. 61/242,117, filed on Sep. 14, 2009.

(30) Foreign Application Priority Data
Jun. 11, 2010 (KR) 10-2010-0055468

(51) Int. Cl. H04N 13/04

(52) U.S. Cl. 348/51; 348/E13.075

(57) ABSTRACT

A signal processing method is provided. The signal processing method includes extracting three-dimensional effect adjustment information from a memory in a video image reproducing apparatus, and adjusting a three-dimensional effect of a video image according to the three-dimensional effect adjustment information, and outputting the video image.

### CROSS-REFERENCE TO RELATED APPLICATION(S)

This application is a continuation application under 35 U.S.C. §§120 and 365(c) of PCT Application No. PCT/KR2010/004416 filed on Jul. 7, 2010, which claims the benefit under 35 U.S.C. §119(a) of Korean Patent Application No. 10-2010-0055468 filed on Jun. 11, 2010, in the Korean Intellectual Property Office and the benefit under 35 U.S.C. §119(e) of U.S. Provisional Application Nos. 61/224,106 filed on Jul. 9, 2009, 61/272,153 filed on Aug. 21, 2009, 61/228,209 filed on Jul. 24, 2009, and 61/242,117 filed on Sep. 14, 2009, the entire disclosures of which are incorporated herein by reference for all purposes.

### BACKGROUND

1. Field

The following description relates to a signal processing method and apparatus therefor using a screen size of a display device.

2. Description of Related Art

Due to advancements in digital technologies, technology for reproducing a video image three-dimensionally has become more widespread.

Since human eyes are separated in a horizontal direction by a predetermined distance, two-dimensional images respectively viewed by the left eye and the right eye are different from each other so that binocular disparity may occur. The human brain combines the different two-dimensional images, a left-eye image and a right-eye image. Thus, a realistically looking three-dimensional image is generated. In order to generate a three-dimensional image using the binocular disparity, a user may wear glasses or—a user may use a device in which a lenticular lens, a parallax barrier, parallax illumination, or the like are arranged therein.

In response to the user wearing the glasses, a level of a three-dimensional effect of an object in an image sensed by the user is affected by a screen size of a display device.

FIG. 1 illustrates a level of a three-dimensional effect sensed by a user being affected by a screen size of a display device. In FIG. 1, a screen size of a right display device is larger than a screen size of a left display device.

When the user views the same image via different display devices each having different sizes, the user sensing a three-dimensional effect viewing the left display device, and a three-dimensional effect sensed by the user viewing the right display device may be indicated as a Depth 1 and a Depth 2, respectively. Equation 1 relates to the three-dimensional effect sensed by the user.

Depth=deye2TV*dobj2obj/(dobj2obj+deye2eye) [Equation 1]

where, ‘Depth’ relates to a three-dimensional effect of an image which is sensed by a user, ‘deye2TV’ relates to a distance between the user and a screen of a display device, ‘dobj2obj’ relates to a horizontal distance between objects in a left-eye image and a right-eye image, and ‘deye2eye’ relates to a distance between a left eye and a right eye of the user.

As defined in Equation 1, ‘Depth’, which corresponds to the three-dimensional effect sensed by the user, may be proportional to 1 ‘deye2TV’ that is the distance between eyes and a television (TV) multiplied by ‘dobj2obj’ that is a distance in an X-axis direction between the objects in the left-eye image and the right-eye image displayed on the display device, and is inversely proportional to the sum of ‘dobj2obj’ and ‘deye2eye.’ The ‘deye2eye’ is the distance between the left and right eyes of the user.

In response to the display devices having different sizes outputting the same image, ‘dobj2obj’ increases as a size of the display device increases. The ‘dobj2obj’ corresponds to the distance in the X-axis direction between the objects in the left-eye image and the right-eye image. This is because a physical distance between pixels is proportional to a size in a horizontal direction of a display device, in response to display devices having different sizes having the same resolution.

Thus, in response to the assumption that ‘deye2eye’ has a fixed value, and ‘deye2TV’ that is the distance between the user and the display device being fixed, the three-dimensional effect sensed by the user corresponds to ‘dobj2obj’. The ‘dobj2obj’ is proportional to the size of the display device.

### SUMMARY

In one general aspect, a signal processing method is provided. The signal processing method includes extracting three-dimensional effect adjustment information from a memory in a video image reproducing apparatus, and adjusting a three-dimensional effect of a video image according to the three-dimensional effect adjustment information, and outputting the video image.

The memory may include a player setting register.

The three-dimensional effect adjustment information may include a screen size of a display device that is connected to the video image reproducing apparatus and outputs the video image.

The screen size may include a horizontal length, a vertical length, a diagonal length of a screen, or any combination thereof.

Before the extracting of the three-dimensional effect adjustment information, the signal processing method may include receiving the screen size from the display device, and storing the screen size in the player setting register.

Before the extracting of the three-dimensional effect adjustment information, the signal processing method may include receiving three-dimensional effect adjustment information selected by a user, and storing the selected three-dimensional effect adjustment information in the memory.

The adjusting of the three-dimensional effect may include extracting an offset value, which corresponds to the three-dimensional effect adjustment information stored in the memory, from an offset conversion table stored in a disc, and adjusting the three-dimensional effect of the video image by using the offset value.

The adjusting of the three-dimensional effect may include extracting an offset value, which corresponds to the three-dimensional effect adjustment information stored in the memory, from an offset conversion table stored in a disc, and adjusting the three-dimensional effect of the video image by using the offset value.

The signal processing method may include adjusting a three-dimensional effect of an audio sound according to the three-dimensional effect adjustment information. The audio sound may be output together with the video image.

The adjusting of the three-dimensional effect of the audio sound may be performed so as to allow the three-dimensional effect of the audio sound to be increased as the screen size of the display device is increased.

The adjusting of the three-dimensional effect of the audio sound may include adjusting a gain of a front audio channel and a surround audio channel according to the screen size of the display device, and mixing gain-adjusted channels.

The three-dimensional effect of the video image may include a depth value, convergence angle, or any combination thereof.

The video image may include a menu graphic stream, a subtitle graphic stream, or any combination thereof.

In another aspect, a signal processing apparatus is provided. The signal processing apparatus includes a memory configured to store three-dimensional effect adjustment information, and a control unit configured to adjust a three-dimensional effect of a video image according to the three-dimensional effect adjustment information.

The memory may include a player setting register.

The three-dimensional effect adjustment information may include a screen size of a display device that is connected to a video image reproducing apparatus and outputs the video image.

The screen size may include a horizontal length, a vertical length, a diagonal length of a screen, or any combination thereof.

The control unit may receive the screen size from the display device, and store the screen size in the player setting register.

The control unit may receive three-dimensional effect adjustment information selected by a user, and store the selected three-dimensional effect adjustment information in the memory.

The control unit may extract an offset value, which corresponds to the three-dimensional effect adjustment information stored in the memory, from an offset conversion table stored in a disc, and adjust the three-dimensional effect of the video image by using the offset value.

The control unit may extract an offset value, which corresponds to the three-dimensional effect adjustment information stored in the memory, from an offset conversion table stored in a disc, and adjust the three-dimensional effect of the video image by using the offset value.

The control unit may adjust a three-dimensional effect of an audio sound according to the three-dimensional effect adjustment information. The audio sound may be output together with the video image.

The control unit may adjust the three-dimensional effect of the audio sound so as to allow the three-dimensional effect of the audio sound to be increased as the screen size of the display device is increased.

The control unit may adjust a gain of a front audio channel and a surround audio channel according to the screen size of the display device, and mix gain-adjusted channels.

As another aspect, a non-transitory computer readable recording medium is provided. The non-transitory computer readable recording medium has recorded thereon a program for executing a signal processing method includes extracting three-dimensional effect adjustment information from a memory in a video image reproducing apparatus, and adjusting a three-dimensional effect of a video image according to the three-dimensional effect adjustment information, and outputting the video image.

As another aspect, a multimedia device is provided. The multimedia device includes a signal processing apparatus including a control unit configured to adjust a three-dimensional effect of a video image according to a three-dimensional effect adjustment information from a memory in the signal processing apparatus.

Other features and aspects may be apparent from the following detailed description, the drawings, and the claims.

### BRIEF DESCRIPTION OF THE DRAWINGS

FIG. 1 is a diagram illustrating an example of a level of a three-dimensional effect sensed by a user is affected by a screen size of a display device;

FIG. 2 is a diagram illustrating an example of a signal processing system;

FIG. 3 is a diagram illustrating an example of a player setting register included in a register of FIG. 2;

FIG. 4 is a diagram illustrating an example of an audio signal processing unit of FIG. 2;

FIG. 5 is a diagram illustrating an example of an audio three-dimensional effect control unit of FIG. 4;

FIG. 6 is a diagram illustrating an example of a three-dimensional effect selection menu;

FIG. 7 is a diagram illustrating an example of an offset conversion table;

FIG. 8 is a diagram illustrating an example of syntax of the offset conversion table;

FIG. 9 is a diagram illustrating an example of a process in which an offset value of an object is adjusted according to three-dimensional effect adjustment information;

FIG. 10 is a diagram illustrating an example of information indicating whether or not to allow an offset value of a video image to be adjusted according to three-dimensional effect conversion information selected by a user;

FIG. 11 is a diagram illustrating an example of syntax of a Stream Number (STN) table;

FIG. 12 is a diagram illustrating an example of the offset conversion table for adjustment of a three-dimensional effect of a graphic stream;

FIG. 13 is a diagram illustrating an example of a convergence angle when a graphic element is output;

FIG. 14 is a diagram illustrating an example of a signal processing apparatus; and

FIG. 15 is a flowchart illustrating an example of a signal processing method.

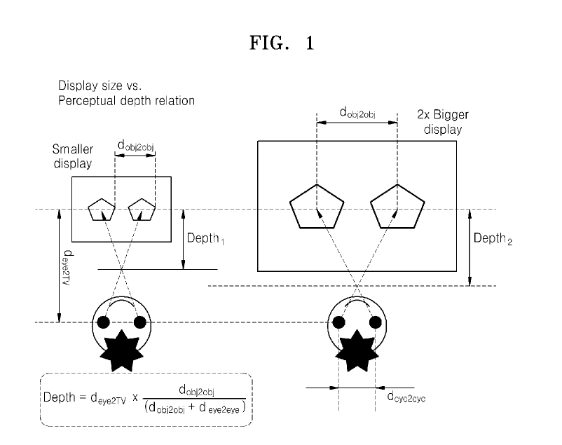

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Hereinafter, the present invention will be described by explaining examples of the invention with reference to the attached drawings. As used herein, the term “and/or” includes any and all combinations of one or more of the associated listed items.

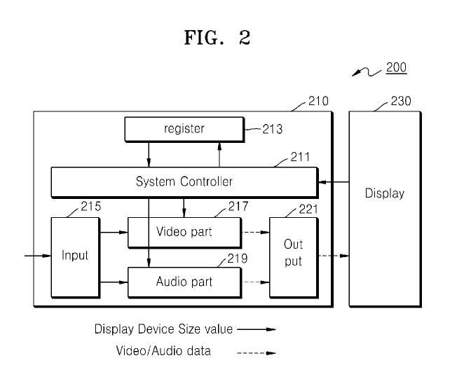

FIG. 2 illustrates an example of a signal processing system 200. The signal processing system 200 may include a signal processing apparatus 210 and a display device 230. In FIG. 2, in one example, the signal processing apparatus 210 and the display device 230 may be separate from each other. In another example, the signal processing apparatus 210 and the display device 230 may be included as units in a device.

The signal processing apparatus 210 and the display device 230 may exchange information via a supported interface. For example, in response to the signal processing apparatus 210 and the display device 230 supporting a High Definition Multimedia Interface (HDMI), the signal processing apparatus 210 and the display device 230 may exchange information via the HDMI. The HDMI is one of video/audio interface standards allowing uncompressed data transmission, and provides an interface between devices supporting the HDMI.

The signal processing apparatus 210 may include a control unit (system controller) 211, a register 213, an input unit 215, a video signal processing unit (video part) 217, an audio signal processing unit (audio part) 219, and an output unit 221.

The input unit 215 may read data from a disc (not shown) loaded in the signal processing apparatus 210 or from a local storage device (not shown), or the input unit 215 may receive data in real-time from a server (not shown) via a communication network. The server may be operated by a broadcasting station or the like. The input unit 215 may send video data to the video signal processing unit 217, and send audio data to the audio signal processing unit 219. The video and audio data may be from among the input data.

The video signal processing unit 217 may decode the video data from the input unit 215, and then generate a left-eye image and a right-eye image for reproduction of a three-dimensional video image. Objects that are to be three-dimensionally reproduced may be mapped in the left-eye image and the right-eye image while the objects are separate from each other by a predetermined distance in left direction, right direction, or any combination thereof.

The audio signal processing unit 219 may decode the audio data from the input unit 215, and then generate an audio signal of a mono channel, a stereo channel, or a multi-channel.

The video signal processing unit 217 and the audio signal processing unit 219 may transmit a video image and the audio signal to the display device 230 via the output unit 221.

The display device 230 may output a signal that is received from the signal processing apparatus 210. The display device 230 may output an overall status of the signal processing apparatus 210, or output the signal received from the signal processing apparatus 210. The display device 230 may include a screen for displaying a video signal, a speaker for outputting the audio signal, or the like.

The register 213 may be an internal memory included in the signal processing apparatus 210. The register 213 may include a player setting register, a playback status register, or any combination thereof. The player setting register may have its contents remain unchanged by a navigation command or an Application Program Interface (API) command in a disc. The playback status register may have a stored value changed according to a reproduction status of the signal processing apparatus 210.

In this example, the player setting register, the playback status register, or any combination thereof may store information to adjust a three-dimensional effect of a video image, an audio sound, or any combination thereof. Here, the information to adjust the three-dimensional effect of the video image, the audio sound, or any combination thereof may correspond to ‘three-dimensional effect adjustment information’.

The three-dimensional effect adjustment information may indicate an actual screen size of the display device 230 connected to the signal processing apparatus 210.

In response to the display device 230 and the signal processing apparatus 210 being connected, the display device 230 may automatically transmit a screen size of the display device 230 to the signal processing apparatus 210 via the interface. The signal processing apparatus 210 may receive the screen size of the display device 230 from the display device 230, and may store the screen size in the register 213. The signal processing apparatus 210 may correspond to the three-dimensional effect adjustment information. In this example, the screen size of the display device 230 may be stored in the player setting register.

In another example, a user may directly input an actual screen size of the display device 230 to the signal processing apparatus 210 via a user interface (not shown), in the case that the display device does not automatically transmit the screen size to the signal processing apparatus 210. The signal processing apparatus 210 may store the actual screen size input by the user in the register 213 as the three-dimensional effect adjustment information.

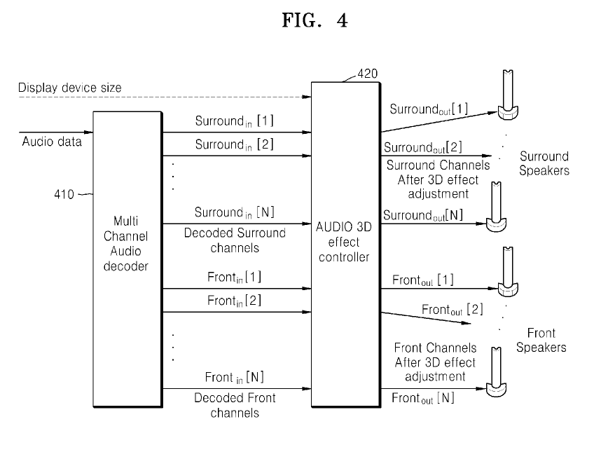

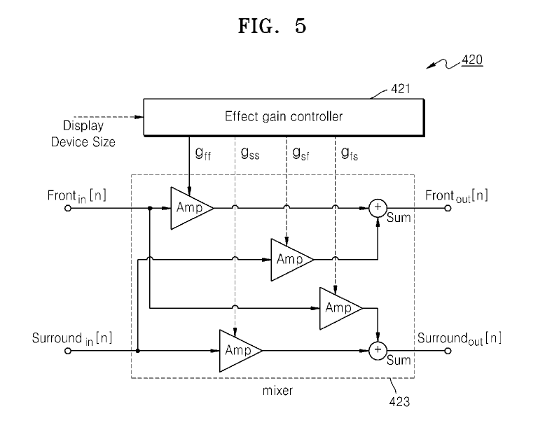

The video signal processing unit 217 may three-dimensionally reproduce the video image, and the audio signal processing unit 219 may also three-dimensionally reproduce the audio signal at substantially the same time as the video signal processing unit 217 reproduces the video image. For this reproduction, the audio signal processing unit 219 may use the three-dimensional effect adjustment information stored in the register 213 to adjust the three-dimensional effect of the audio sound. A method performed by the audio signal processing unit 219 using the three-dimensional effect adjustment information to adjust the three-dimensional effect of the audio sound will be described with reference to FIGS. 4 and 5.

The display device 230 may alternately output the left-eye image and the right-eye image to three-dimensionally reproduce the video image, and simultaneously output the audio signal having a three-dimensional sound effect.

According to the present example, storing the three-dimensional effect adjustment information in the internal memory of the signal processing apparatus 210 and using the three-dimensional effect adjustment information, may be possible, to allow the three-dimensional sound effect to be adjusted in relation to a level of a three-dimensional visual effect.

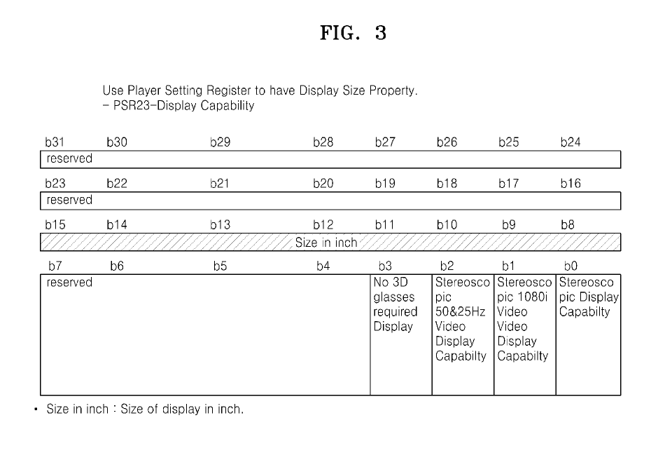

FIG. 3 illustrates an example of the player setting register included in the register 213 of FIG. 2. Referring to FIG. 3, the player setting register may store a total of 32 bits, and the three-dimensional effect adjustment information may be stored in at least one predetermined bit from among the 32 bits. For example, the three-dimensional effect adjustment information may indicate the screen size (in units of inches) of the display device 230. The screen size may include a horizontal length value, a vertical length value, a diagonal length value of a screen, or any combination thereof.

FIG. 4 illustrates an example of the audio signal processing unit 219 of FIG. 2. The audio signal processing unit 219 may include a multi-channel audio decoder 410 and an audio three-dimensional effect control unit 420.

The multi-channel audio decoder 410 may decode audio data input via the input unit 215 to restore a multi-channel audio signal. Referring to FIG. 4, the multi-channel audio decoder 410 may include N (where N is a natural number) surround channels and N front channels and may decode and restore the multi-channel audio signal.

The multi-channel audio decoder 410 transmits the restored multi-channel audio signal to the audio three-dimensional effect control unit 420. The audio three-dimensional effect control unit 420 may adjust a three-dimensional effect of the received multi-channel audio signal.

The audio three-dimensional effect control unit 420 may change a three-dimensional effect of an audio sound so as to correspond to a three-dimensional effect of a video image. For example, in response to an object included in a three-dimensional video image having a depth so that the object seems to be projected from the screen by a predetermined distance, a three-dimensional effect of an audio signal reproduced together with the three-dimensional video image may be adjusted so that the audio signal seems to be heard at a position projected by the predetermined distance, similar to the object. The audio three-dimensional effect control unit 420 may receive three-dimensional effect adjustment information as a control signal from the register 213 in the signal processing apparatus 210.

In response to the three-dimensional effect adjustment information indicating the screen size of the display device 230, the audio three-dimensional effect control unit 420 may use the received screen size of the display device 230 to mix N front channels and N surround channels, and then generate new N front channels and new N surround channels, respectively.

A larger screen size of the display device 230 may correspond to a greater three-dimensional visual effect. The audio three-dimensional effect control unit 420 may adjust a three-dimensional sound effect of the audio signal so as to correspond to the three-dimensional effect of the video image generated by the video signal processing unit 217.

In response to the screen size of the display device 230 being larger than a predetermined size, the audio three-dimensional effect control unit 420 may increase a sound difference of the audio signal between a front channel and a surround channel, and in response to the screen size of the display device 230 being smaller than the predetermined size, the audio three-dimensional effect control unit 420 may decrease the sound difference between the front channel and the surround channel so that the three-dimensional sound effect of the audio signal becomes weaker corresponding to the three-dimensional visual effect becoming weaker. The audio three-dimensional effect control unit 420 may adjust the three-dimensional sound effect of the audio signal according to the screen size of the display device 230 to generate the new N front channels and the new N surround channels, and then transmit the new N front channels and the new N surround channels to the display device 230.

The display device 230 may include a front speaker and a surround speaker. The front speaker and the surround speaker included in the display device 230 may output the new N front channels and the new N surround channels, respectively.

FIG. 5 illustrates an example of the audio three-dimensional effect control unit 420 of FIG. 4. The audio three-dimensional effect control unit 420 may include a gain adjusting unit 421 and a mixing unit 423.

The gain adjusting unit 421 uses three-dimensional effect adjustment information to adjust a gain of amplifiers included in the mixing unit 423.

In response to the three-dimensional effect adjustment information indicating the screen size of the display device 230, the gain adjusting unit 421 may extract the screen size of the display device 230 from the player setting register, and adjust the gain of the amplifiers using the three-dimensional effect adjustment information indicating the screen size.

The mixing unit 423 uses a gain received from the gain adjusting unit 421 to adjust the gain of the amplifiers, mixes gain-adjusted channels, and then generates a new channel. As another aspect, the mixing unit 423 mixes an nth front channel and an nth surround channel, and then generates a new channel.

In response to the screen size of the display device 230 being significantly large, the gain adjusting unit 421 adjusts gain values input to four amplifiers that are included in the mixing unit 423 to control a channel, which is input to the audio three-dimensional effect control unit 420, to be output without a change. In other words, the gain adjusting unit 421 adjusts the gain values so as to satisfy Frontout[n]=Frontin[n], and Surroundout[n]=Surroundin[n]. By doing so, a three-dimensional sound effect applied to original audio data in response to original audio data was generated by a content provider being maximally applied to the channel. In order to satisfy Frontout[n]=Frontin[n], and Surroundout[n]=Surroundin[n], the gain values gff, gss, gsf, and gfs correspond to 1, 1, 0, and 0, respectively,

In response to the screen size of the display device 230 being significantly small so that a three-dimensional visual effect is insignificant, the audio three-dimensional effect control unit 420 minimizes a three-dimensional sound effect to correspond to the three-dimensional visual effect of a video image. For this minimizing operation, the gain adjusting unit 421 re-adjusts the gain values, which are input to the four amplifiers included in the mixing unit 423, so as to satisfy Frontout[n]=0.5*Frontin[n]+0.5*Surroundin[n], and Surroundout[n]=0.5*Surroundin[n]+0.5*Frontin[n]. By performing the minimization, the three-dimensional sound effect applied to the original audio data when the original audio data was generated by the content provider is controlled to be minimal.

In another example, instead of the screen size of the display device 230, a setting value according to a user preference may be used as the three-dimensional effect adjustment information. A user may appropriately mix the gain values according to the user preference, may select a random value between a combination of the gain values in order to maximize the three-dimensional sound effect of an audio sound, and a combination of the gain values in order to minimize the three-dimensional sound effect of the audio sound, and then may adjust a maximum and a minimum of the three-dimensional sound effect of the audio signal.

In this manner, the three-dimensional sound effect of the audio signal may vary according to the maximum and minimum of the three-dimensional visual effect based on the screen size of the display device 230. By doing so, the three-dimensional sound effect and the three-dimensional visual effect may be naturally related to each other. Also, the three-dimensional sound effect of the audio signal may be adjusted according to user preference.

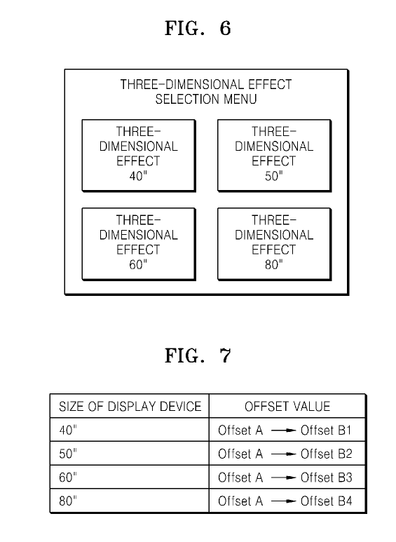

FIG. 6 illustrates an example of a three-dimensional effect selection menu. The three-dimensional effect selection menu allows a user to directly select three-dimensional effect adjustment information.

As described above, a three-dimensional effect of a video image, which is sensed by a user viewing the display device 230, may be proportional to the screen size of the display device 230. In response to the display device 230 being excessively large, binocular disparity may also be so great that the user may feel visual fatigue. As another aspect, in response to the display device 230 being excessively small, the user may barely sense or not sense at all the three-dimensional effect of the video image. Also, a level of a depth of the video image preferred by a user may be different from a three-dimensional effect according to the screen size of the display device 230. Thus, the user may use the three-dimensional effect selection menu of FIG. 6 to directly select a desired three-dimensional effect of the video image.

The signal processing apparatus 210 may store a screen size in the register 213, as three-dimensional effect adjustment information. The register 213 may be the internal memory, and the screen size may be selected by the user via the three-dimensional effect selection menu. The screen size selected by the user may be stored in the playback status register. Via the three-dimensional effect selection menu, the user may change the selected screen size to another value.

In response to the screen size selected by the user being stored in the playback status register, as the three-dimensional effect adjustment information, the video signal processing unit 217 may use the screen size selected by the user to adjust a depth of a three-dimensional video image. In other words, the video signal processing unit 217 may generate a left-eye image and a right-eye image so that a mapping position of an object is moved a predetermined distance in a left direction or a right direction. The predetermined distance corresponds to the screen size selected by the user.

The audio signal processing unit 219 may also adjust a three-dimensional sound effect of an audio signal to correspond to the screen size selected by the user.

For example, in response to the display device 230, which is connected to the signal processing apparatus 210 and outputs a video image, having a screen size of 60 inches and a user selecting 40 inches via the three-dimensional effect selection menu, the signal processing apparatus 210 may adjust a three-dimensional effect of the video image so as to correspond to 40 inches. A screen size selected by the user is 40 inches. The 40 inches is different from an actual screen size of the display device 230. The signal processing apparatus 210 may also adjust a three-dimensional effect of an audio signal to correspond to the three-dimensional effect of the video image.

In one example, the three-dimensional effect selection menu may be included in a disc loaded in the signal processing apparatus 210. In another example, the signal processing apparatus 210 may directly generate the three-dimensional effect selection menu and then provide the selection menu to the user via a screen or the like.

While the three-dimensional effect selection menu in FIG. 6 is only related to the screen size of the video image, the example is not limited thereto. Thus, the three-dimensional effect selection menu may be related to adjustment of the three-dimensional effect of the audio signal. In this case, the user may adjust a desired three-dimensional effect of the audio signal via the three-dimensional effect selection menu.

Thus, in this example, the user may directly select the three-dimensional effect adjustment information via the three-dimensional effect selection menu.

FIG. 7 illustrates an example of an offset conversion table. The offset conversion table may store offset values according to three-dimensional effect adjustment information, and the offset conversion table may be recorded in a disc loaded in the signal processing apparatus 210.

An offset value may correspond to a distance between a position of an object in a two-dimensional image and a position of an object in left-eye or right-eye images for three-dimensionally reproducing the two-dimensional image. As the offset value increases, the distance between the position of the object in the two-dimensional image and the position of the object in the left-eye or right-eye images also increases. Accordingly, a three-dimensional effect of a video image is further increased.

In response to an actual screen size of the display device 230 or a user-selected screen size being stored as the three-dimensional effect adjustment information in the register 213, the signal processing apparatus 210 may read an offset value corresponding to the three-dimensional effect adjustment information in the offset conversion table, and use the offset value to adjust a three-dimensional effect of a video image.

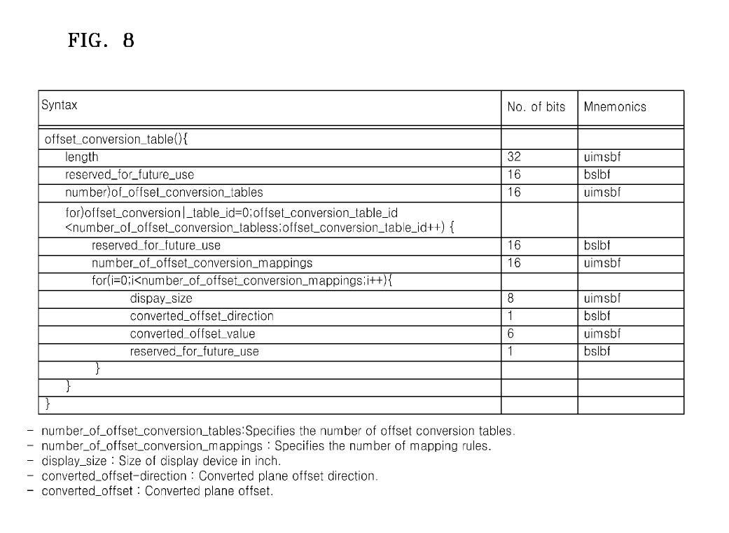

FIG. 8 illustrates an example of syntax of the offset conversion table. Referring to FIG. 8, 8 bits are allocated to a display size (display_size) in the syntax of the offset conversion table, and according to each display size, 1 bit and 6 bits are allocated to an offset direction (converted_offset_direction) and an offset value (converted_offset_value), respectively.

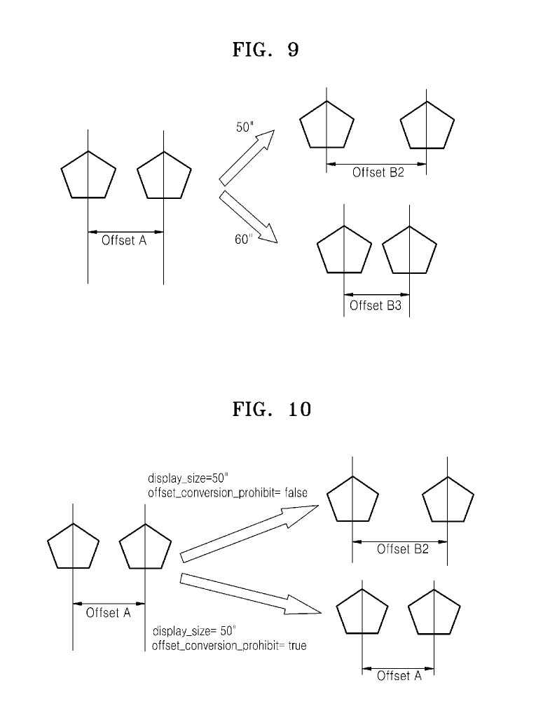

FIG. 9 illustrates an example of a process in which an offset value of an object is adjusted according to three-dimensional effect adjustment information. As described above, the internal memory of the signal processing apparatus 210 stores, as the three-dimensional effect adjustment information, the actual screen size of the display device 230 or the user-selected screen size. The signal processing apparatus 210 extracts the three-dimensional effect adjustment information from the register 213, and extracts an offset value from the offset conversion table. The offset value corresponds to the three-dimensional effect adjustment information. The signal processing apparatus 210 may move the object in a left or right direction by a distance corresponding to the offset value extracted from the offset conversion table to adjust a three-dimensional effect of a video image.

In FIG. 9, in response to the user-selected screen size being 50 inches, the signal processing apparatus 210 may extract an offset value B2 corresponding to a screen size of 50 inches in the offset conversion table of FIG. 7. The signal processing apparatus 210 may generate a left-eye image and a right-eye image in which an object is mapped at a position moved to by the offset value B2 in a left or right direction. In response to the user-selected screen size being 60 inches, the signal processing apparatus 210 may extract an offset value B3 corresponding to a screen size of 60 inches in the offset conversion table of FIG. 7, and generate a left-eye image and a right-eye image in which an object is mapped at a position moved to by the offset value B3 in a left or right direction.

In this manner, according to the present example, the signal processing apparatus 210 may extract the offset value from the offset conversion table, and may adjust the three-dimensional effect of the video image. The offset value may correspond to the three-dimensional effect adjustment information.

FIG. 10 illustrates an example of information indicating whether or not to allow an offset value of a video image to be adjusted according to three-dimensional effect conversion information selected by a user.

In response to the user-selected screen size being stored in the register 213 as the three-dimensional effect adjustment information, according to the present example, the register 213 may further store information indicating whether or not to allow an offset value of an object to be adjusted according to three-dimensional effect conversion information selected by a user.

Since the information indicating whether or not to allow the offset value of the object to be adjusted according to the three-dimensional effect conversion information selected by the user may be randomly changed by the user, the information may be stored in the playback status register of the register 213.

A content provider (author) may use a navigation command or a JAVA API function to perform a programming operation so that a user may select whether or not to allow a three-dimensional effect of a video image to be adjusted according to user selection. The user to may use a menu screen to set allowance or non-allowance in the signal processing apparatus 210. The allowance or non-allowance may be related to whether or not to allow a three-dimensional effect of a video image and an audio sound to be adjusted according to three-dimensional effect adjustment information selected by the user.

In FIG. 10, in response to the user-selected screen size being 50 inches, and the register 213 includes information (offset_conversion_prohibit=false) allowing an offset value to be adjusted according to the user-selected screen size, the signal processing apparatus 210 may read the offset value B2 corresponding to the user-selected screen size of 50 inches from the offset conversion table of FIG. 7, and generate a left-eye image and a right-eye image in which an object is mapped at a position moved by the offset value B2 in a left or right direction.

In response to the register 213 of the signal processing apparatus 210 including information (offset_conversion_prohibit=true) prohibiting an offset value from being adjusted according to the user-selected screen size, the signal processing apparatus 210 may use a pre-defined offset value A to generate a left-eye image and a right-eye image, regardless of the user-selected screen size. An object in the left-eye image and the right-eye image may be mapped at a position moved by the offset value A in a left or right direction.

In addition, the information allowing or prohibiting adjustment of the offset according to the user-selected screen size may also be used to allow or prohibit user-adjustment of a three-dimensional effect of an audio sound. The user-selected screen size may be stored in the register of the signal processing apparatus 210.

In this manner, according to the present example, the internal memory of the signal processing apparatus 210 may further store the information indicating whether or not to allow the three-dimensional effect of the video image and audio sound to be adjusted according to the three-dimensional effect conversion information selected by the user.

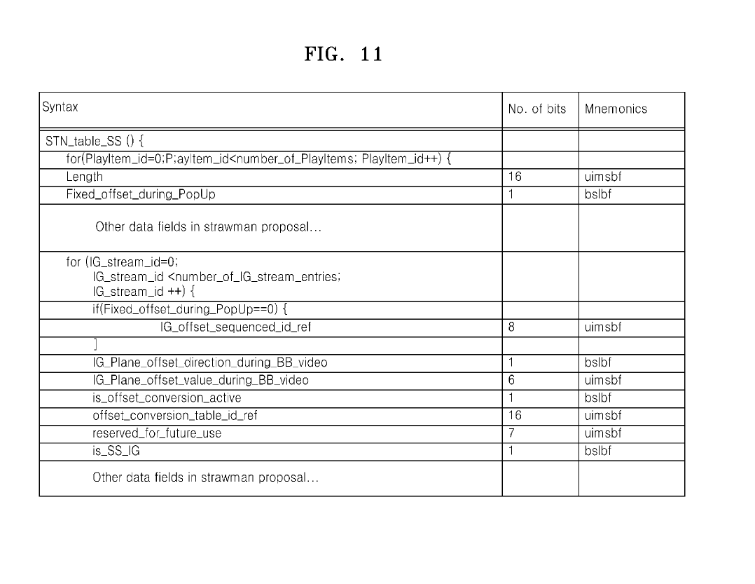

FIG. 11 illustrates an example of syntax of a Stream Number (STN) table.

The STN table may be included in a disc at which a navigation file including an index file, a playlist file or clip information is stored.

In the present example, the STN table may include information indicating whether or not to allow a graphic element to be three-dimensionally converted according to three-dimensional effect adjustment information. The graphic element may be reproduced together with a video image. For this, a content manufacturer (author) may generate information indicating whether to allow a menu graphic stream or a subtitle graphic stream to be three-dimensionally converted according to the three-dimensional effect adjustment information, and may store the information in the STN table, as illustrated in FIG. 11. The menu graphic stream or the subtitle graphic stream may be stored in the disc.

A three-dimensional video image may be displayed together with a graphic element including a menu or a subtitle which is additionally provided with respect to a video image. In response to the video image being three-dimensionally reproduced, the graphic element may be two-dimensionally or three-dimensionally reproduced. Also, the video image may be two-dimensionally reproduced, and only the graphic element reproduced together with the video image may be three-dimensionally reproduced.

According to the present example, In response to the video image being two-dimensionally reproduced, and the graphic element reproduced together with the video image being three-dimensionally reproduced, the signal processing apparatus 210 may use the screen size of the display device 230, or use the user-selected screen size to adjust a three-dimensional effect of the graphic element.

Referring to FIG. 11, identification of an interactive graphic stream (IG_stream_id) may be indicated in the syntax of the STN table. Also, the syntax of the STN table may include information (is_offset_conversation_active) indicating whether or not to allow conversion of a three-dimensional effect of each interactive graphic stream.

In response to the STN table including information allowing conversion of a three-dimensional effect of an interactive graphic stream having a predetermined ID, an ID (offset_conversation_table_id_ref) of an offset conversion table to be applied to the interactive graphic stream having the predetermined ID is included in the STN table. The offset conversion table may include offset values corresponding to the screen size of the display device 230.

The offset conversion table indicated in the STN table may be the same table as the offset conversion table in relation to FIG. 7 or FIG. 8, or may be different from the offset conversion table in relation to FIG. 7 or FIG. 8 in that the offset conversion table indicated in the STN table may store the offset values with respect to interactive graphic streams, instead of a video image, whereas the offset conversion table in relation to FIG. 7 or FIG. 8 may store the offset values with respect to a video image.

The signal processing apparatus 210 may extract the offset conversion table having the

ID of the offset conversion table from a disc, and may convert a three-dimensional effect of an interactive graphic stream according to an offset value in the offset conversion table.

The signal processing apparatus 210 may extract an offset value corresponding to the screen size of the display device 230 from the offset conversion table, and may convert the three-dimensional effect of the interactive graphic stream by using the offset value. Also, the signal processing apparatus 210 may extract an offset value corresponding to the user-selected screen size from the offset conversion table, and may convert the three-dimensional effect of the interactive graphic stream by using the offset value

In this manner, according to the present example, the three-dimensional effect of the graphic element may be adjusted by using the screen size of the display device 230.

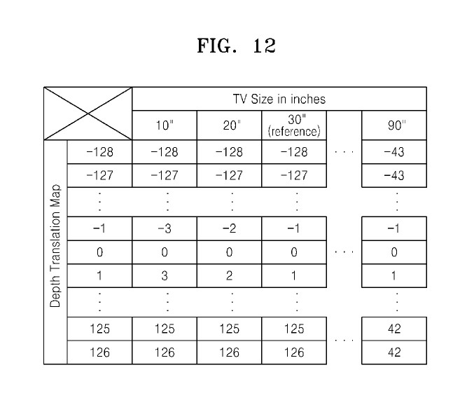

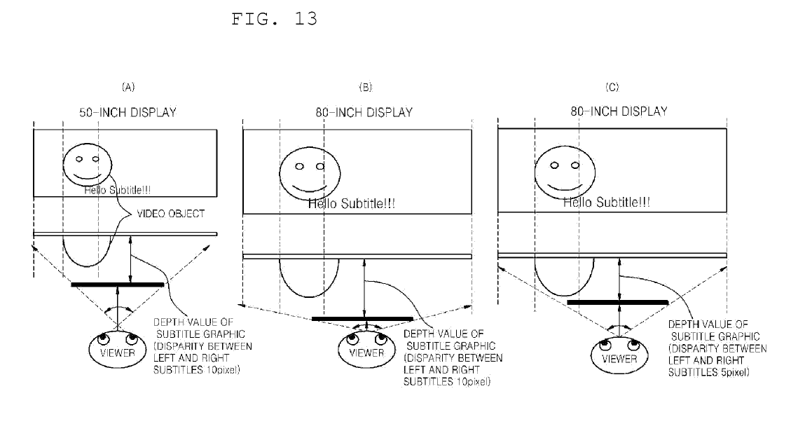

FIG. 12 illustrates an example of the offset conversion table for adjustment of a three-dimensional effect of a graphic stream. In response to a graphic element being reproduced together with a video image, the graphic element including a menu or a subtitle may naturally be output while projected forward, compared to the video image. As described above, since a three-dimensional effect of the video image varies according to the screen size of the display device 230, in response to the screen size of the display device 230 being significantly large, the three-dimensional effect of the video image may be increased, and a three-dimensional effect of the graphic element may be further increased. The three-dimensional effect of the graphic element may be output while projected forward in comparison to the video image. In response to a user viewing the graphic element having a large three-dimensional effect, a convergence angle is increased such that the user may feel visual fatigue. For example, in response to the user viewing a subtitle graphic that is formed based on a 50-inch display device and is displayed on the 50-inch display device, and in response to the user viewing the same subtitle graphic displayed on a 80-inch display device with the same resolution, the convergence angle may be greater in the case of the 80-inch display device than in the case of the 50-inch display device so that visual fatigue may also be increased.

Thus, adjustment of the three-dimensional effect of the graphic element may be necessary to decrease the convergence angle of the graphic element.

Referring to FIG. 12, reference offset values may be indicated in a left most side of the offset conversion table. The offset conversion table of FIG. 12 may include offset values to be converted according to screen sizes of display devices in response to a graphic stream that is formed based on a 30-inch display device being output by using the display devices having the different screen sizes. In the present example, a content provider making an offset conversion table may allow offset values to be included in the offset conversion table, where the offset values are adjusted to be less than predetermined values to prevent a convergence angle from increasing excessively.

Referring to the offset conversion table of FIG. 12, absolute values of the offset values to be converted may decrease as the screen sizes increase. The offset values are converted to be less than their original values in response to the screen sizes increasing, and by doing so, a depth of the graphic element increasing according to an increase in the screen sizes may be prevented.

The signal processing apparatus 210 may use the offset conversion table of FIG. 12 to extract offset values according to a screen size of a display device where the graphic element is to be displayed, and may use the offset values to output the graphic element whose three-dimensional effect is adjusted on a screen.

FIG. 13 illustrates a convergence angle in response to a graphic element being output. (A) of FIG. 13 illustrates a convergence angle of a case in response to a graphic stream formed based on a 50-inch display device being output via the 50-inch display device. In (A) of FIG. 13, a disparity between the left and the right of a graphic element in a left-eye image and a right-eye image may be 10 pixels.

(B) of FIG. 13 illustrates a convergence angle in response to the graphic stream being output via a 80-inch display device. In response to the graphic stream formed based on the 50-inch display device being output via the 80-inch display device having the same resolution as the 50-inch display device, a disparity between the left and the right of a graphic element in a left-eye image and a right-eye image is 10 pixels as in (A) of FIG. 13. However, since a pixel length increases in proportion to a screen size, the convergence angle in (B) of FIG. 13 may be larger than the convergence angle in (A) of FIG. 13. In this case, a user may feel visual fatigue.

(C) of FIG. 13 illustrates a convergence angle of a case in response to offset values being converted by using an offset conversion table including offset values that are adjusted to be less than predetermined values. The signal processing apparatus 210 may extract the screen size of the display device 230 from the player setting register, and extract offset values according to the screen size of the display device 230 from an offset conversion table like the offset conversion table of FIG. 12. The offset conversion table may be stored in a disc.

The signal processing apparatus 210 may use the extracted offset values to convert an offset value of a graphic element, and adjust a three-dimensional effect of the graphic element. Likewise in the case of (B) of FIG. 13, although the same graphic stream is output via the 80-inch display device in the case of (C) of FIG. 13, the offset values are converted to values less than their original values by using the offset conversion table, and thus the three-dimensional effect of the graphic element is decreased, as compared to the case of (B) of FIG. 13. Referring to the case of (C) of FIG. 13, a disparity seen between the left and the right of a graphic element in a left-eye image and a right-eye image may be decreased to 5 pixels, and the convergence angle in (C) of FIG. 13 may be smaller than the convergence angle in (B) of FIG. 13.

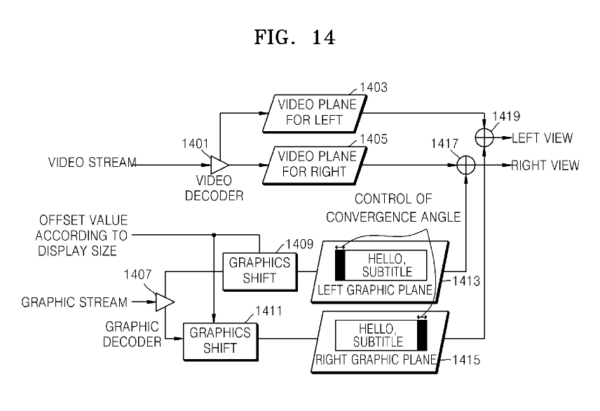

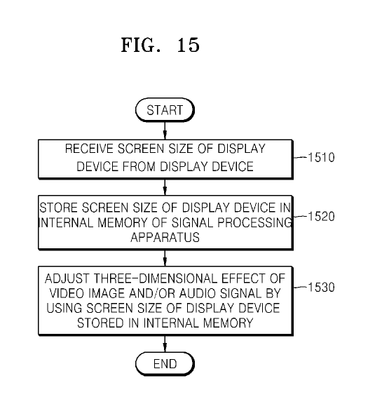

FIG. 14 illustrates an example of a signal processing apparatus. Referring to FIG. 14, the signal processing apparatus includes a video decoder 1401, a left-eye video plane 1403, a right-eye video plane 1405, a graphic decoder 1407, graphic shift units 1409 and 1411, a left-eye graphic plane 1413, a right-eye video plane 1415, and signal synthesizers 1417 and 1419.

The video decoder 1401 decodes a video stream to generate a left-eye image and a right eye image, and draws the left-eye image in the left-eye video plane 1403, and the right eye image in the right-eye video plane 1405, respectively.

The graphic decoder 1407 may decode a graphic stream to generate a left-eye graphic and a right eye graphic.

The graphic shift units 1409 and 1411 control the left-eye graphic and the right eye graphic to be moved a predetermined distance in a left or right direction, and then to be drawn in the left-eye graphic plane 1413 and the right-eye video plane 1415, respectively. The left-eye graphic and the right eye graphic may be generated by the graphic decoder 1407. Here, the predetermined distance in the left or right direction may be determined according to the offset conversion table of FIG. 12. The graphic shift units 1409 and 1411 may move the left-eye graphic and the right-eye graphic the predetermined distance in the left or right direction. That is, the graphic shift units 1409 and 1411 refer to the offset conversion table of FIG. 12 to extract an offset value according to a screen size of a display device, and control a graphic to be drawn at a position moved by the extracted offset value in a left or right direction.

In this case, the graphic drawn in the left-eye graphic plane 1413 and the right-eye video plane 1415 is at the position moved in the left or right direction by the offset value according to the screen size of the display device. In other words, as the screen size of the display device is increased, a distance by which a graphic moves in a left or right direction in a graphic plane is decreased so that a three-dimensional effect of a graphic element is decreased. Also, as the screen size of the display device is decreased, the distance by which the graphic moves in the left or right direction is increased so that the three-dimensional effect of the graphic element is increased.

The signal synthesizers 1417 and 1419 may add the left-eye graphic drawn in the left-eye graphic plane 1413 to the left-eye image drawn in the left-eye video plane 1403, and add the right-eye graphic drawn in the right-eye graphic plane 1415 to the right-eye image drawn in the right-eye video plane 1405, respectively.

In this manner, according to the present example, in consideration of the screen size of the display device, a depth of the graphic element may be adjusted so as to allow a convergence angle of a user to be within a predetermined range.

FIG. 15 illustrates an example of a signal processing method. Referring to FIG. 15, a screen size of a display device may be received from the display device (operation 1510). In response to the screen size of the display device not being received from the display device, the screen size of the display device may be received directly from a user.

A signal processing apparatus may store the screen size of the display device in an internal memory (operation 1520).

The signal processing apparatus may use the screen size of the display device stored in the internal memory to adjust a three-dimensional effect of a video image, an audio signal, or any combination thereof (operation 1530).

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A signal processing method comprising:
extracting three-dimensional effect adjustment information from a memory in a video image reproducing apparatus; and
adjusting a three-dimensional effect of a video image based on the three-dimensional effect adjustment information, and outputting the video image,
wherein the three-dimensional effect adjustment information comprises information relates to screen size of a display device that is connected to the video image reproducing apparatus and outputs the video image.

2. The signal processing method of claim 1, wherein the memory comprises a player setting register.

3. The signal processing method of claim 2, wherein the screen size comprises a horizontal length, a vertical length, a diagonal length of a screen, or any combination thereof.

4. The signal processing method of claim 2, before the extracting of the three-dimensional effect adjustment information, further comprising:
receiving the screen size from the display device; and
storing the screen size in the player setting register.

5. The signal processing method of claim 1, before the extracting of the three-dimensional effect adjustment information, further comprising:
receiving three-dimensional effect adjustment information selected by a user; and
storing the selected three-dimensional effect adjustment information in the memory.

6. The signal processing method of claim 4, wherein the adjusting of the three-dimensional effect comprises:
extracting an offset value, which corresponds to the three-dimensional effect adjustment information stored in the memory, from an offset conversion table stored in a disc; and
adjusting the three-dimensional effect of the video image by using the offset value.

7. The signal processing method of claim 5, wherein the adjusting of the three-dimensional effect comprises:
extracting an offset value, which corresponds to the three-dimensional effect adjustment information stored in the memory, from an offset conversion table stored in a disc; and
adjusting the three-dimensional effect of the video image by using the offset value.

8. The signal processing method of claim 2, further comprising adjusting a three-dimensional effect of an audio sound according to the three-dimensional effect adjustment information, wherein the audio sound is output together with the video image.

9. The signal processing method of claim 8, wherein the adjusting of the three-dimensional effect of the audio sound is performed so as to allow the three-dimensional effect of the audio sound to be increased as the screen size of the display device is increased.

10. The signal processing method of claim 9, wherein the adjusting of the three-dimensional effect of the audio sound comprises:
adjusting a gain of a front audio channel and a surround audio channel according to the screen size of the display device; and
mixing gain-adjusted channels.

11. A signal processing apparatus comprising:
a memory configured to store three-dimensional effect adjustment information; and
a control unit configured to adjust a three-dimensional effect of a video image based on the three-dimensional effect adjustment information,
wherein the three-dimensional effect adjustment information comprises information relates to screen size of a display device that is connected to the video image reproducing apparatus and outputs the video image.

12. The signal processing apparatus of claim 11, wherein the memory comprises a player setting register.

13. The signal processing apparatus of claim 12, wherein the screen size comprises a horizontal length, a vertical length, a diagonal length of a screen, or any combination thereof.

14. The signal processing apparatus of claim 12, wherein the control unit receives the screen size from the display device, and stores the screen size in the player setting register.

15. The signal processing apparatus of claim 11, wherein the control unit receives three-dimensional effect adjustment information selected by a user, and stores the selected three-dimensional effect adjustment information in the memory.

16. The signal processing apparatus of claim 14, wherein the control unit extracts an to offset value, which corresponds to the three-dimensional effect adjustment information stored in the memory, from an offset conversion table stored in a disc; and
adjusts the three-dimensional effect of the video image by using the offset value.

17. The signal processing apparatus of claim 15, wherein the control unit extracts an offset value, which corresponds to the three-dimensional effect adjustment information stored in the memory, from an offset conversion table stored in a disc; and
adjusts the three-dimensional effect of the video image by using the offset value.

18. The signal processing apparatus of claim 12, wherein the control unit adjusts a three-dimensional effect of an audio sound according to the three-dimensional effect adjustment information, and
wherein the audio sound is output together with the video image.

19. The signal processing apparatus of claim 18, wherein the control unit adjusts the three-dimensional effect of the audio sound so as to allow the three-dimensional effect of the audio sound to be increased as the screen size of the display device is increased.

20. The signal processing apparatus of claim 19, wherein the control unit adjusts a gain of a front audio channel and a surround audio channel according to the screen size of the display device; and mixes gain-adjusted channels.

21. A non-transitory computer readable recording medium having recorded thereon a program for executing a signal processing method comprising:
extracting three-dimensional effect adjustment information from a memory in a video image reproducing apparatus; and
adjusting a three-dimensional effect of a video image based on the three-dimensional effect adjustment information, and outputting the video image,
wherein the three-dimensional effect adjustment information comprises information relates to screen size of a display device that is connected to the video image reproducing apparatus and outputs the video image.

22. A multimedia device comprising:
a signal processing apparatus including:
a control unit configured to adjust a three-dimensional effect of a video image based on a three-dimensional effect adjustment information,
wherein the three-dimensional effect adjustment information comprises information relates to screen size of a display device that is connected to the video image reproducing apparatus and outputs the video image.

23. The signal processing method of claim 1, wherein the three-dimensional effect of the video image includes a depth value, convergence angle, or any combination thereof.
